(19) United States
(12) Patent Application Publication
(10) Pub. No.: US 2024/0160378 A1
(43) Pub. Date: May 16, 2024

(54) INFORMATION PROCESSING DEVICE, VEHICLE, INFORMATION PROCESSING METHOD, AND COMPUTER-READABLE STORAGE MEDIUM

(71) Applicants: TOYOTA JIDOSHA KABUSHIKI KAISHA, Toyota-shi (JP); DENSO CORPORATION, Kariya-city (JP)

(72) Inventors: Jun IWAMOTO, Nagoya-shi (JP); Junichiro TAMAO, Tokyo-to (JP); Norihide KOHMOTO, Nisshin-shi (JP); Toshiaki ISOGAI, Kariya-city (JP); Tomohiro TAKAHASHI, Kariya-city (JP)

(73) Assignees: TOYOTA JIDOSHA KABUSHIKI KAISHA, Toyota-shi (JP); DENSO CORPORATION, Kariya-city (JP)

(21) Appl. No.: 18/386,866

(22) Filed: Nov. 3, 2023

(30) Foreign Application Priority Data
Nov. 16, 2022 (JP) 2022-183752

(51) Int. Cl. G06F 3/06

(52) U.S. Cl. CPC G06F 3/0655; G06F 3/0604; G06F 3/0673

(57) ABSTRACT

An information processing device includes: a control section controlling rewriting of a recording device installed in a vehicle; and a setting section that, on the basis of a first maximum number of times of rewriting that corresponds to a first interval in which functions of the recording device are guaranteed, sets a second maximum number of times of rewriting in a second interval that is an interval that is shorter than the first interval.

### CROSS-REFERENCE TO RELATED APPLICATION

This application is based on and claims priority under 35 USC § 119 from Japanese Patent Application No. 2022-183752 filed on Nov. 16, 2022, the disclosure of which is incorporated by reference herein.

### BACKGROUND

### Technical Field

The present disclosure relates to an information processing device, a vehicle, an information processing method, and a computer-readable storage medium.

### Related Art

Japanese Patent Application Laid-Open (JP-A) No. 2016-170604 (Patent Document 1) discloses a technique that makes it possible to judge the life of a memory, while keeping the storage region for storing the number of times of writing small. In this technique, a value obtained by adding the maximum value of the number of times of writing counted in an operation time period, and a value that is stored in a storage region of the memory that stores the number of times, is updated as the maximum number of times of writing, and whether or not the life of the memory has been reached is judged on the basis of the maximum number of times of writing.

By the way, there are cases in which a warranty period in which writing is possible is set at a storage. In such products at which a warranty period is set, there is room for improvement in techniques of ensuring the warranty period.

### SUMMARY

An object of the present disclosure is to provide an information processing device, a vehicle, an information processing method, and an information processing program that can ensure the warranty period of a product that is a recording device.

An information processing device relating to a first aspect includes: a control section controlling rewriting of a recording device installed in a vehicle; and a setting section that, on the basis of a first maximum number of times of rewriting that corresponds to a first interval in which functions of the recording device are guaranteed, sets a second maximum number of times of rewriting in a second interval that is an interval that is shorter than the first interval.

The information processing device relating to the first aspect sets a maximum number of times of rewriting while taking plural intervals into consideration. Here, examples of the intervals are time period and distance. In rewriting of the recording device, the time period is set as a period of time or a number of days over which the recording device is used at the vehicle. In rewriting of the recording device, the distance is set as the traveled distance of the vehicle in which the recording device is installed. Due thereto, the warranty period of the product that is the recording device can be ensured. Further, rewriting, which is beyond what was expected, of the recording device is suppressed, and the warranty period can be ensured.

In an information processing device relating to a second aspect, the information processing device relating to the first aspect can further include a managing section, wherein the managing section can carry out restricting of rewriting in a case in which is it judged that the second maximum number of times of rewriting has been exceeded in the second interval.

In accordance with the information processing device relating to the second aspect, by restricting rewriting, rewriting is restricted such that the warranty period can be ensured, and trouble before the warranty period is suppressed.

In an information processing device relating to a third aspect, in the information processing device relating to the first aspect, the recording device can be requested to secure a storage region per application, and, in accordance with a request for securing, the setting section can set the second maximum number of times of rewriting on the basis of the first maximum number of times of rewriting, the second interval, and a proportion of a secured region that that application is attempting to secure, per application.

In accordance with the information processing device relating to the third aspect, by setting a maximum number of times of rewriting per application, trouble before the warranty period due to, for example, rewriting a specific application at a high frequency is suppressed.

In an information processing device relating to a fourth aspect, in the information processing device relating to the third aspect, in securing a storage region for the application, in a case of receiving a designation of an expected write size per predetermined interval that is shorter than the second interval, if a number of times of rewriting corresponding to the expected write size exceeds a maximum number of times of rewriting of a present point in time, the setting section can allocate a number of times of rewriting corresponding to the expected write size as the second maximum number of times of rewriting, and, if the number of times of rewriting corresponding to the expected write size does not exceed the maximum number of times of rewriting, the setting section can allocate the maximum number of times of rewriting of the present point in time as the second maximum number of times of rewriting.

In accordance with the information processing device relating to the fourth aspect, in a case in which there is a designation of an expected write size, the maximum number of times of rewriting that corresponds to the designation is set. Due thereto, managing of the maximum number of times, which corresponds to the form of usage of the application, is possible.

In an information processing device relating to a fifth aspect, in the information processing device relating to the fourth aspect, the setting section can compute the maximum number of times of rewriting of the present point in time on the basis of a maximum number of times at which rewriting of the recording device is possible per predetermined interval that is computed by using a remaining number of times of rewriting of the present point in time and a predetermined remaining product life of the recording device, and a proportion of the secured region of the application with respect to physical size of the recording device, and the second interval that is the secured interval of the application, and the setting section can compute the number of times of rewriting corresponding to the expected write size on the basis of the number of times of rewriting corresponding to the expected write size and the second interval that is the secured interval of the application. In accordance with the information processing device of the fifth aspect, in a case in which there is a designation of an expected write size, a maximum number of times of rewriting that corresponds to the designation can be set.

In an information processing device relating to a sixth aspect, the information processing device relating to the first aspect can further include a managing section, wherein the managing section can update a remaining number of times of the first maximum number of times of rewriting and a remaining number of times of the second maximum number of times of rewriting, each time that writing to the recording device is carried out. In accordance with the information processing device of the sixth aspect, the remaining number of times is updated, and management that is needed to ensure the product warranty period is possible.

In an information processing device relating to a seventh aspect, in the information processing device relating to the first aspect, a unit of the interval in the first interval and the second interval can be a time period from shipping-out of the recording device from a factory, or traveled distance of the vehicle in which the recording device is installed. In accordance with the information processing device of the seventh aspect, setting and managing of the maximum number of times of rewriting are possible in accordance with the time period or the traveled distance that serve as forms of rewriting that are handled at the recording device.

A vehicle relating to an eighth aspect includes: the information processing device relating to the first aspect; and onboard equipment to which results of execution of an application managed by the information processing device are outputted.

In an information processing method relating to a ninth aspect, a computer executes processings of: controlling rewriting of a recording device installed in a vehicle; and, on the basis of a first maximum number of times of rewriting that corresponds to a first interval in which functions of the recording device are guaranteed, setting a second maximum number of times of rewriting in a second interval that is an interval that is shorter than the first interval.

An information processing program relating to a tenth aspect causes a computer to execute processings of: controlling rewriting of a recording device installed in a vehicle; and, on the basis of a first maximum number of times of rewriting that corresponds to a first interval in which functions of the recording device are guaranteed, setting a second maximum number of times of rewriting in a second interval that is an interval that is shorter than the first interval.

In accordance with the technique of the present disclosure, the warranty period of a product that is a recording device can be ensured.

### BRIEF DESCRIPTION OF THE DRAWINGS

FIG. 1 is a drawing illustrating the schematic structure of a vehicle relating to embodiments;

FIG. 2 is a block drawing illustrating hardware structures of the vehicle of the embodiments;

FIG. 3 is a block drawing illustrating functional structures of a central ECU of the embodiments;

FIG. 4 is a flowchart of setting processing of a first embodiment;

FIG. 5 is a flowchart of managing processing of the first embodiment;

FIG. 6 is a flowchart of setting processing of a second embodiment; and

FIG. 7 is a flowchart of setting processing of a modified example.

### DETAILED DESCRIPTION

An overview of embodiments of the present invention is described. In vehicles, there are cases in which plural applications are controlled by an ECU (Electronic Control Unit). In such a vehicle, the life of the storage must be guaranteed for unpredictable writing of data by the plural applications. Life depletion issues of the storage include recalls at automobile-related businesses and the like, and ensuring of the warranty period of the storage is an important topic.

In conventional techniques, the number of times of rewriting cannot be predicted, and there is the possibility that the life of the storage will expire within the warranty period that is guaranteed for the ECU, and rewriting will no longer be possible. In such a case, OTA (Over the Air) software updates are no longer possible during the product warranty period.

Further, the addition of and utilization of numerous, unspecified applications by OTA, and cases in which the addition of applications is planned at times specified by the user or a business, are services provided by the ECU. Applications that are added to the ECU include numerous, various applications in accordance with the intended uses of the services, and there are also cases in which third-party applications are added. Due to such circumstances, it is difficult to predict the number of applications and the number of times of rewriting of the applications.

Thus, in the present embodiment, the warranty period of the product is taken into consideration, and a maximum of the number of times that rewriting is possible within a given time period is allocated per application installed in the ECU. If the allocated maximum number of times is exceeded, data rewriting of the application is prohibited.

### First Embodiment

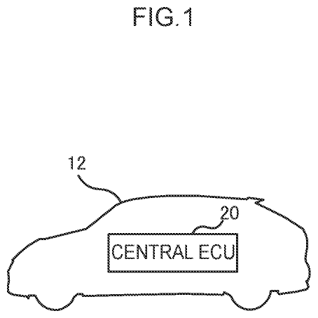

As illustrated in FIG. 1, in a first embodiment of the present invention, a central ECU 20 is installed in a vehicle 12. The central ECU 20 is an example of the “information processing device” of the technique of the present disclosure.

In the first embodiment, a maximum number of times of rewriting per secured time period for each application is set. In a case in which the rewriting processing of an application is carried out, each time that rewriting is completed, the remaining number of times with respect to the maximum number of times of rewriting is updated. Processing is carried out in which, at the time of rewriting, it is judged whether or not the remaining number of times of rewriting is exceeded, and, if the remaining number of times is exceeded, rewriting is prohibited.

(Vehicle)

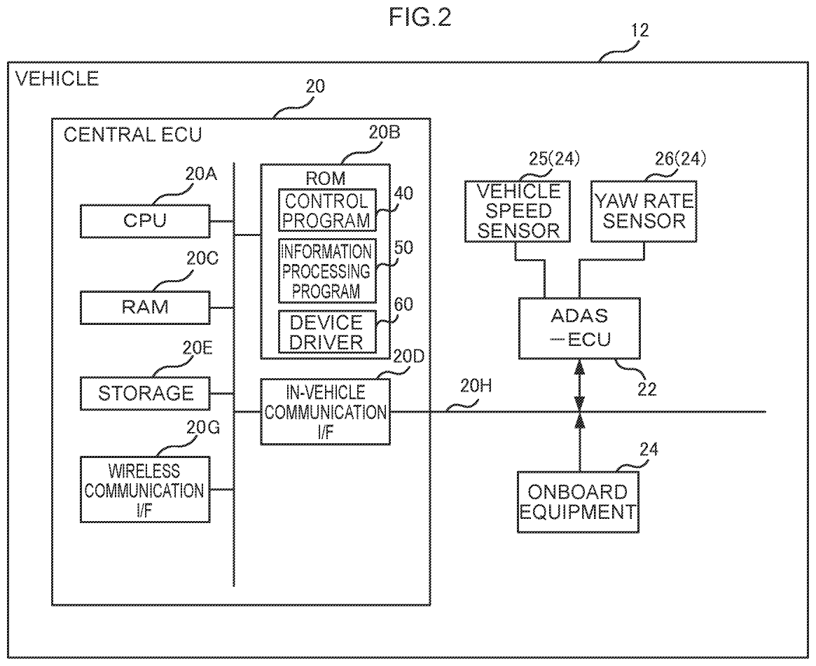

As illustrated in FIG. 2, the vehicle 12 relating to the present embodiment is structured to include the central ECU 20, an ADAS-ECU 22 and onboard equipment 24. Note that ECUs that are other than the ADAS-ECU 22 (e.g., a body ECU, a multimedia ECU and the like) may be connected to the central ECU 20.

The central ECU 20 is structured to include a CPU (Central Processing Unit) 20A, a ROM (Read Only Memory) 20B, a RAM (Random Access Memory) 20C, an in-vehicle communication I/F (Interface) 20D, and a wireless communication I/F 20G. The CPU 20A, the ROM 20B, the RAM 20C, the in-vehicle communication I/F 20D, a storage 20E, and the wireless communication I/F 20G are connected so as to be able to communicate with one another via internal bus 20H. Note that the CPU 20A may be structured by plural CPUs. The storage 20E is an example of the recording device of the technique of the present disclosure.

The CPU 20A is a central computing processing unit, and executes various programs and controls respective sections. Namely, the CPU 20A reads-out a program from the ROM 20B, and executes the program by using the RAM 20C as a workspace.

The ROM 20B stores various programs and various data. A control program 40, which utilizes functions of various application programs of the vehicle 12, is stored in the ROM 20B of the present embodiment. Further, an information processing program 50 is stored in the ROM 20B. In the present embodiment, the information processing program 50 manages the maximum number of times of rewriting of the storage 20E for each application, and permits or restricts writing of the application. Further, a device driver 60 is stored in the ROM 20B. A remaining number of times, which is the remaining life of the storage 20E itself, is stored in the device driver 60. The information processing program 50 and the device driver 60 function as storage coordinators. A storage coordinator is a coordinator provided at the central ECU 20 in order to mediate between the storage regions and the applications executed by the user. A storage coordinator provides functions such as improving the efficiency of utilization by varying the regions of the storage that are used, preventing a specific application from monopolizing storage, managing access levels, and the like.

The RAM 20C temporarily stores programs and data as a workspace. The data that is handled by the information processing program 50 is held in the RAM 20C.

The in-vehicle communication I/F 20D is the interface for connecting to the ADAS-ECU 22 and the onboard equipment 24. Communication standards in accordance with CAN protocol are used at this interface. The in-vehicle communication I/F 20D is connected to the external bus 20H.

The storage 20E is a storage region (hereinafter simply called region) in which data of the respective applications that are executed by the control program 40 and the like are stored. Note that the storage 20E is set such that access thereto and writing therein are permitted via the information processing program 50. Note that, at the storage 20E, an upper limit of the region that can be secured may be set per application. Or, the upper limit of the time period over which an application can secure a region may be set at the storage 20E.

The wireless communication I/F 20G is a wireless communication module for communication with an external server. Communication standards such as, for example 5G, LTE, Wi-Fi® and the like are used at this wireless communication module. The wireless communication I/F 20G is connected to network N.

Further, although not illustrated for convenience of explanation, the central ECU 20 has functions that are responsible for steering control, braking control, engine control, control of information systems such as the car navigation system, the audio system and the like, and the like.

The ADAS-ECU 22 carries out integrated control of the advance driving assist system. A vehicle speed sensor 25 and a yaw rate sensor 26 that structure the onboard equipment 24 are connected to the ADAS-ECU 22.

Note that, in addition to these, a steering angle sensor, a brake actuator, a throttle actuator, a display, and other sensors are included among the onboard equipment 24 as equipment necessary to realize the functions of the central ECU 20. Further, the results of executing the applications managed by the central ECU 20 are outputted to the onboard equipment 24 in accordance with the specifications of the applications.

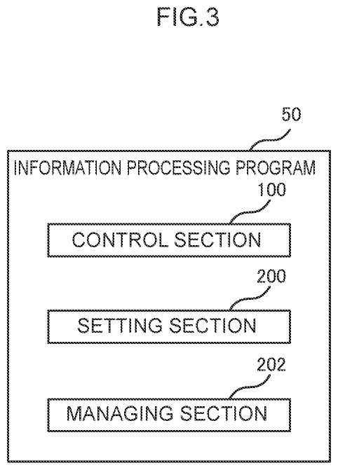

As illustrated in FIG. 3, at the central ECU 20 of the present embodiment, due to the CPU 20A executing the information processing program 50, the CPU 20A functions as a control section 100, a setting section 200 and a managing section 202. Note that, the following description explains, as an example, a case in which the unit of a day (a 24-hour unit) is used as the unit of the time period, but a unit of an arbitrary time period may be set.

The control section 100 controls the rewriting, by applications, of the storage 20E installed in the central ECU 20 of the vehicle 12. In the rewriting control by the control section 100, rewriting can be restricted by the managing section 202 that is described later.

The setting section 200 receives a request from an application to secure a region of the storage 20E, and sets the maximum number of times of rewriting per application. Details are described in the flow of control that is described hereinafter.

Due to the managing section 202 receiving a rewrite request from an application and processing the rewrite request, the managing section 202 manages the number of times of rewriting of the entire storage 20E and the maximum numbers of times of rewriting of the applications in accordance with the rewriting of the storage 20E. Details are described in the flow of control that is described hereinafter.

(Flow of Control)

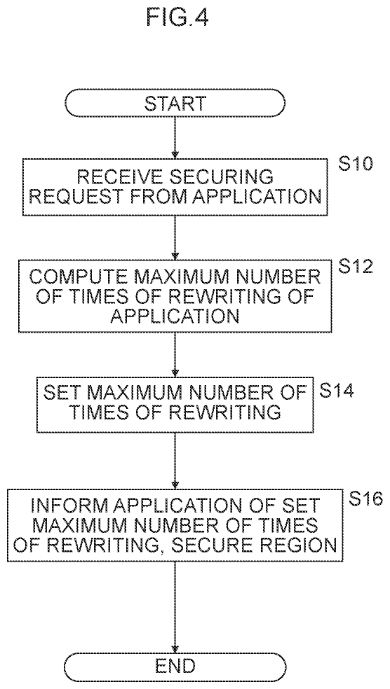

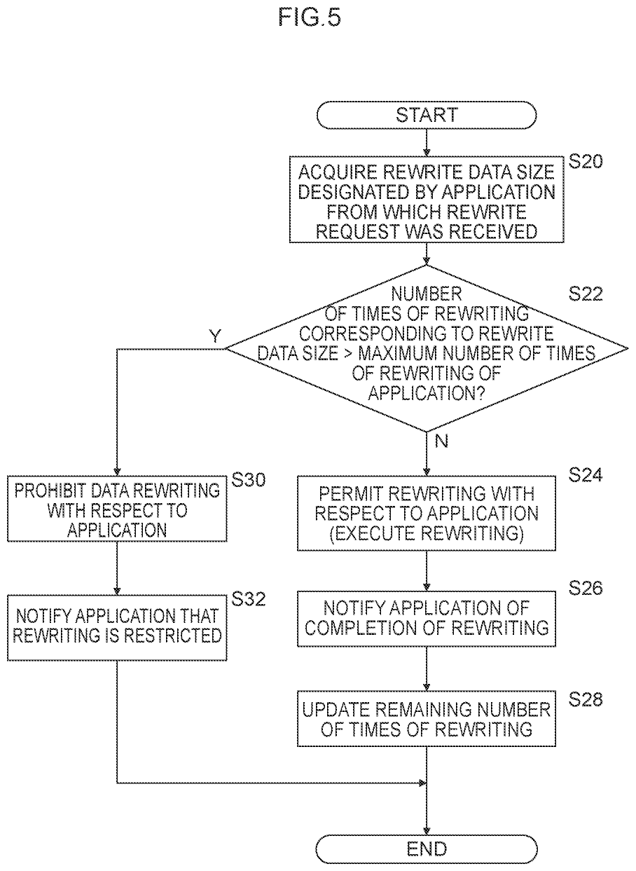

The flows of the setting processing and the managing processing that serve as the information processing method executed by the central ECU 20 of the present embodiment are described by using the flowcharts of FIG. 4 and FIG. 5.

As the setting section 200, the CPU 20A receives requests to secure regions of the storage 20E from the respective applications, and executes the setting processing illustrated in the flowchart of FIG. 4. The setting processing is carried out individually for each of the plural applications used in the vehicle 12. For example, the setting processing is executed each time that an application is installed or updated. The installing or updating of an application occurs, for example, when the ignition is turned on, or when an application is newly added. Further, in a case in which an application is uninstalled from the storage 20E, the maximum number of times of rewriting that application, which was set in the setting processing, is reset or is deleted.

In step S10, the CPU 20A receives a securing request from an application. Information such as the secured size [MB] and secured time period [days] are included in the securing request. The secured size [MB] is the size that the application is attempting to secure in the storage regions that the storage 20E has.

In step S12, the CPU 20A computes the maximum number of times of rewriting of the application from which the securing request was received. The maximum number of times of rewriting per application can be computed by following formula (1).

maximum number of times of rewriting per application=overall maximum number of times (times/day)·proportion (%) of secured region of application·secured time period [days] (1)

The proportion (%) of the region secured for the application is the proportion of the secured size [MB] for which securing was requested from the application, with respect to the entire size of the storage regions that the storage 20E has. The secured time period [days] is the number of days over which an application will secure and occupy a storage region. The secured time period is determined in accordance with a designation by the application and is, for example, 1.5 days (36 hours), 4 days (96 hours), or the like. After the secured time period [days] elapses, the secured region in the storage 20E is appropriately cleared. In above formula (1), the maximum number of times of rewriting per application in the secured time period [days] is computed.

The overall maximum number of times (times/day) is the maximum number of times of rewriting (times/day) of the entire storage region at which rewriting is possible per one day, and is computed by following formula (2). Note that the entire storage region means, of the regions of the storage 20E, common regions of the storage 20E that are allocated for use by the applications.

overall maximum number of times (times/day)=maximum number of times of rewriting that is the life of the entire storage region÷product warranty period (days) (2)

The product warranty period (days) is the number of days of the guaranteed time period of the product over which the functions of the storage 20E are guaranteed, and is a number of days that is provided to the storage 20E at the time when the product ships-out from the factory. The maximum number of times of rewriting, which is the life of the entire storage region, is the maximum number of times of rewriting that is guaranteed, at the time of shipping-out from the factory, as the number of times that rewriting at the storage 20E is possible. Here, a number of times that is appropriate as the maximum number of times of rewriting, which is obtained from results of measuring at the time of production or the like, is set as the maximum number of times of rewriting that is the life of the entire storage region. Further, an average number of times of rewriting that is anticipated per day is set in accordance with the results of measurement or the like and future plans. Therefore, an appropriate number of days is set as the warranty period (days) of the product, by comprehensively considering the average number of times of rewriting that is anticipated per day, the maximum number of times of rewriting that is the life of the entire storage region, the guaranteed number of days that is the minimum necessary for the product, and the like. Accordingly, the maximum number of times of rewriting that is the life of the entire storage region corresponds to and has a relationship with the product warranty period (days) that is set.

Note that the warranty period (days) of the product at the time of shipping-out from the factory is an example of the first interval in which the functions of the recording device of the present disclosure are guaranteed. The maximum number of times of rewriting that is the life of the entire storage region is an example of the first maximum number of times of rewriting that corresponds to the first interval of the present disclosure. Further, the secured time period [days] is an example of the second interval that is shorter than the first interval of the present disclosure and is the secured interval. The maximum number of times of rewriting per application is an example of the second maximum number of times of rewriting of the present disclosure.

In step S14, the CPU 20A sets the maximum number of times of rewriting for the application from which a securing request was received.

In step S16, the CPU 20A informs the application, from which the securing request was received, of the maximum number of times of rewriting that was set therefor, and secures a region for that application in the storage 20E.

Managing processing is described next. In the managing processing illustrated in the flowchart of FIG. 5, requests for rewriting the storage 20E are received from the respective applications, and the CPU 20A executes the managing processing as the managing section 202. The managing processing is carried out individually for each of the plural applications used at the vehicle 12. The managing processing is executed each time that a processing requiring rewriting arises during execution of the application.

In step S20, the CPU 20A acquires a rewrite data size designated by the application from which a rewrite request was received. Note that the number of times of rewriting that corresponds to the rewrite data size is prescribed in the storage 20E.

In step S22, the CPU 20A judges whether or not the number of times of rewriting that corresponds to the rewrite data size exceeds the maximum number of times of rewriting of the application. If it is judged that the maximum number of times is not exceeded, the CPU 20A moves on to step S24. If it is judged that the maximum number of times is exceeded, the CPU 20A moves on to step S30.

In step S24, the CPU 20A permits rewriting for the application from which the rewrite request was received. Due to this permission, rewriting of the data of the storage 20E by the application is executed.

In step S26, the CPU 20A informs the application, from which the rewrite request was received, that rewriting has been completed.

In step S28, the CPU 20A updates the remaining number of times of rewriting for the application from which the rewrite request was received. Note that, in each instance of data rewriting that arises at the storage 20E, the remaining number of times of rewriting of the entire storage 20E also is updated due to subtraction from the maximum number of times of rewriting.

In step S30, the CPU 20A prohibits rewriting for the application from which a rewrite request was received.

In step S32, the CPU 20A informs the application, from which the rewrite request was received, that rewriting is restricted. The application that receives this notice informs the user via the display of the onboard equipment 24, or the like.

As described above, the central ECU 20 that serves as the information processing device of the present embodiment sets a maximum number of times of rewriting for each application, and limits rewriting of greater than or equal to the maximum number of times of rewriting that has been set for the application. Because rewriting is managed on an application-by-application basis in this way, it is possible to suppress an application unexpectedly using up the number of times of rewriting of the storage. In accordance with the above-described present embodiment, the warranty period of the product that is the recording device can be ensured.

### Second Embodiment

A second embodiment is an aspect in which processing is carried out on the basis of the expected write size and the remaining product life, in accordance with the absence/presence of a designation of the expected write size per day of an application. The second embodiment has structures in common with the first embodiment, and therefore, only processings that differ are described hereinafter. In the second embodiment, the setting processing of the setting section 200 differs from the first embodiment. Note that the time period of one day per day for which the expected write size is designated in the second embodiment is an example of the predetermined interval of the present disclosure.

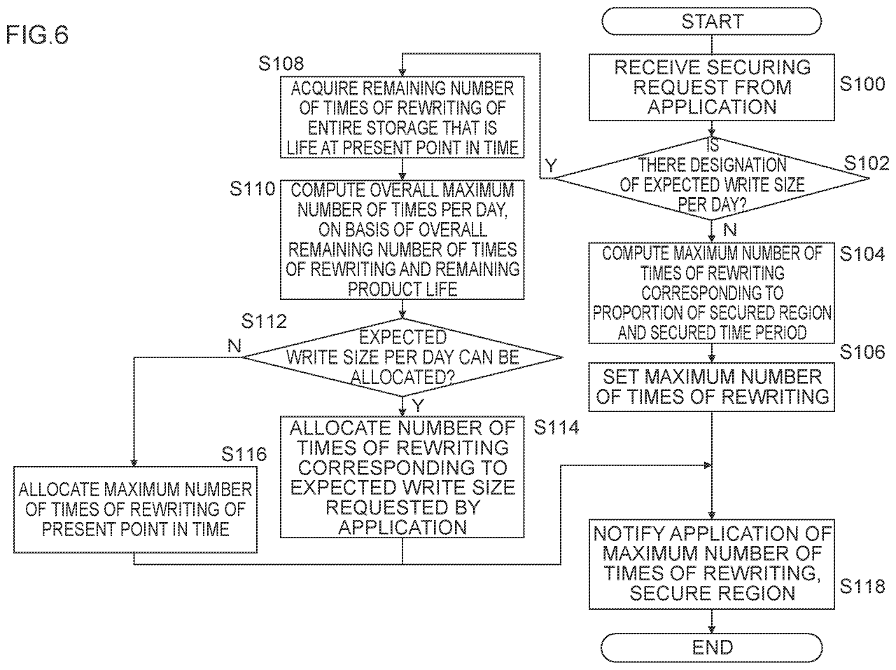

FIG. 6 is a flowchart of the setting processing of the second embodiment.

In step S100, the CPU 20A receives a securing request from an application. In the second embodiment, the securing request includes the secured size [MB] and the secured time period [days], and, if there is such a designation, information of the “expected write size per day”.

In step S102, the CPU 20A judges whether or not there is a designation of the expected write size per day. If there is no such designation, the CPU 20A moves on to step S104. If there is a designation, the CPU 20A moves on to step S108.

In step S104, the CPU 20A computes the maximum number of times of rewriting that corresponds to the proportion (%) of the secured region and the secured time period [days], for the application from which the securing request was received. The method of computing is similar to that of step S21 of the first embodiment.

In step S106, the CPU 20A sets the maximum number of times of rewriting, which was computed in step S104, for the application from which the securing request was received.

In step S108, the CPU 20A acquires, from the device driver 60, the remaining number of times of rewriting of the entire storage 20E, which is the life from the present point in time.

In step S110, on the basis of the remaining number of times of rewriting and the remaining product life [days] from the present point in time of the entire storage 20E, the CPU 20A computes the maximum number of times that rewriting is possible per day of the entire storage 20E in accordance with following formula (3).

maximum number of times that rewriting is possible per day of entire storage 20E (times/day)=remaining number of times of rewriting of entire storage 20E÷remaining product life (days) (3)

The remaining product life [days] is the number of days obtained by subtracting the number of days [days] after shipment from the factory from the product warranty period [days].

In step S112, the CPU 20A judges whether or not the expected write size per day can be allocated. If it is judged that allocation is possible, the CPU 20A moves on to step S114. If it is judged that allocation is not possible, the CPU 20A moves on to step S116. This judgement is a judgement that allocation is possible in a case in which the relationship of following α1 and β1 satisfies the condition α1>β1. α1 expresses the maximum number of times of rewriting at the present point in time of the storage 20E, and β1 expresses the number of times of rewriting that corresponds to the expected write size that the application requested.
α1: maximum number of times of entire storage 20E that rewriting is possible per day·proportion (%) of secured region of application with respect to physical size of storage 20E·secured time period [days]
β1: number of times of rewriting corresponding to expected write size per day·secured time period [days]

In step S114, the CPU 20A allocates, to the application from which the securing request was received, a number of times of rewriting corresponding to the expected write size requested by that application. This is a number of times determined by above β1. Further, the CPU 20A secures a region for that application in the storage 20E.

In step S116, the CPU 20A allocates, to the application from which the securing request was received, the maximum number of times of rewriting of the storage 20E of the present point in time. This is a number of times determined by above α1. Further, the CPU 20A secures a region for that application in the storage 20E.

In step S118, the CPU 20A informs the application, from which the securing request was received, of the maximum number of times of rewriting allocated to that application, and secures a region for that application in the storage 20E.

In accordance with the above-described present embodiment, the maximum number of times of rewriting that is allocated can be varied in accordance with the remaining number of times of rewriting of the storage 20E at the present point in time. Due thereto, in the present embodiment, the warranty period of the product that is the recording device can be ensured, while taking into consideration updating of the remaining number of times of rewriting of the entire storage 20E.

### Modified Example

A modified example of the above-described second embodiment is described. The embodiments describe examples of cases in which the secured time period is used as the unit for setting the maximum number of times of rewriting. However, the present disclosure is not limited to this, and, for example, the unit of the interval in the present disclosure can be made to be the traveled distance [km] of the vehicle 12.

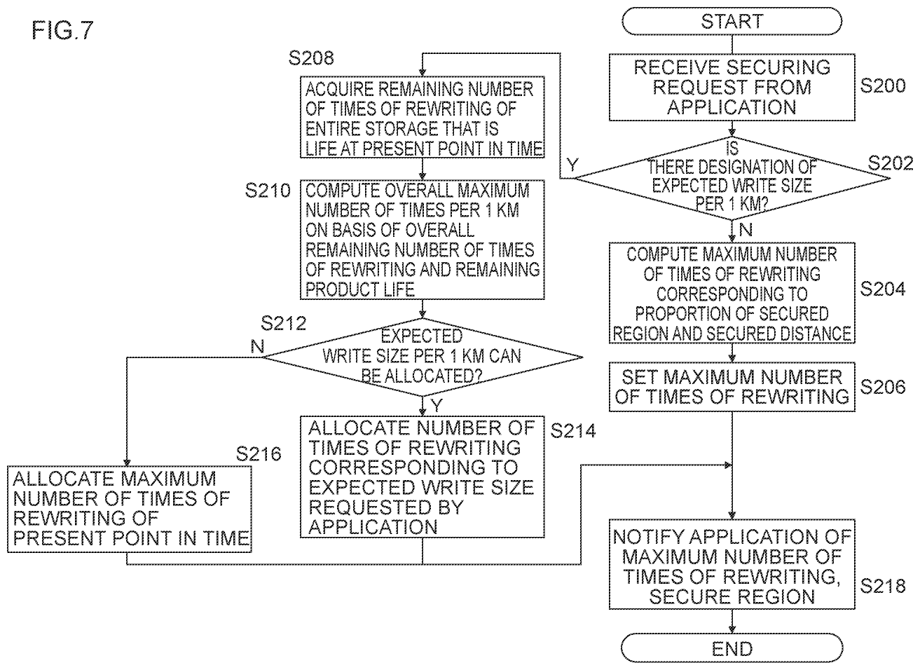

FIG. 7 is a flowchart of the setting processing of the modified example.

In step S200, the CPU 20A receives a securing request from an application. In the second embodiment, the securing request includes secured size [MB], secured distance [km] and, if there is such a designation, information of the “expected write size per 1 km”. The secured distance [km] is the traveled distance for which the application requests securing. The secured distance [km] is an example of the second interval that is a secured interval of the present disclosure.

In step S202, the CPU 20A judges whether or not there is a designation of the expected write size per 1 km. If it is judged that there is no such designation, the CPU 20A moves on to step S204. If it is judged that there is a designation, the CPU 20A moves on to step S208.

In step S204, the CPU 20A computes the maximum number of times of rewriting that corresponds to the proportion (%) of the secured region and the secured distance [km], for the application from which the securing request was received. For the method of computing, it suffices to use a computing method similar to that of step S22 of the first embodiment, and to replace time period with distance.

In step S206, the CPU 20A sets the maximum number of times of rewriting, which was computed in step S204, for the application from which the securing request was received.

In step S208, the CPU 20A acquires, from the device driver 60, the remaining number of times of rewriting of the entire storage 20E, which is the life from the present point in time.

In step S210, on the basis of the remaining number of times of rewriting and the remaining product life [km] of the entire storage 20E, the CPU 20A computes the maximum number of times that rewriting is possible per day of the entire storage 20E in accordance with following formula (4).

maximum number of times of entire storage 20E that rewriting is possible per 1 km (times/km)=remaining number of times of rewriting of entire storage 20E÷remaining product life (km) (4)

The remaining product life [km] is the distance obtained by subtracting the traveled distance [km] after shipment from the factory from the traveled distance [km] guaranteed for the product.

In step S212, the CPU 20A judges whether or not the expected write size per 1 km can be allocated. If such allocation is judged to be possible, the CPU 20A moves on to step S214. If such allocation is judged to be impossible, the CPU 20A moves on to step S216. This judgement is a judgement of possible in a case in which the relationship of following α2 and β2 satisfies the condition α2>β2. α2 is the maximum number of times of rewriting at the present point in time of the storage 20E, and β2 is the number of times of rewriting that corresponds to the expected write size that the application requested.
α2: maximum number of times of entire storage 20E that rewriting is possible per 1 km·proportion of secured region of application with respect to physical size of storage 20E·secured distance [km]
β2: number of times of rewriting corresponding to expected write size per 1 km·secured distance [km]

In step S214, the CPU 20A allocates, to the application from which the securing request was received, the number of times of rewriting that corresponds to the expected write size requested by that application. This is a number of times determined by above β2.

In step S216, the CPU 20A allocates, to the application from which the securing request was received, the maximum number of times of rewriting of the storage 20E of the present point in time. This is a number of times determined by above α2.

In step S218, the CPU 20A informs the application, from which the securing request was received, of the maximum number of times of rewriting allocated to that application, and secures the region for that application in the storage 20E.

In accordance with the above-described present embodiment, in a case in which managing of the life of the storage 20E is carried out on the basis of the traveled distance, the warranty period of the product that is the recording device can be ensured while taking into consideration updating of the remaining number of times of rewriting of the entire storage 20E.

Note that, although the above embodiments describe examples of cases of setting and managing the maximum number of times of rewriting per application, the present disclosure is not limited to this. For example, instead of using an application as the unit, a group of applications may be used as the unit, and application groups corresponding to types of applications may be provided, and the setting and managing of the maximum number of times of rewriting may be carried out per application group. In this case, for example, the secured region of the application group is made to be the total of the secured regions that are secured in advance for the respective applications at the time of setting the application groups, and the longest interval of the applications of the application group is used as the secured interval, or the like. Due thereto, setting processing is not carried out each time for each application, and it suffices to carry out the setting processing and set a maximum number of times of rewriting for the application group. The managing processing is carried out per application, but the remaining number of times of rewriting that is set for the application group is updated. Due thereto, even in a case in which there is a large number of applications, a reduction in the number of records needed for setting and managing the maximum number of times of rewriting is devised, and the embodiments can be realized while the processing amount is reduced.

Note that any of various types of processors other than a CPU may execute the various processings that are executed due to the CPU 20A reading-in software (programs) in the above-described embodiments. Examples of processors in this case include PLDs (Programmable Logic Devices) whose circuit structure can be changed after production such as FPGAs (Field-Programmable Gate Arrays) and the like, and dedicated electrical circuits that are processors having circuit structures that are designed for the sole purpose of executing specific processings such as ASICs (Application Specific Integrated Circuits) and the like, and the like. Further, the above-described respective processings may be executed by one of these various types of processors, or may be executed by a combination of two or more of the same type or different types of processors (e.g., plural FPGAs, or a combination of a CPU and an FPGA, or the like). Further, the hardware structures of these various types of processors are, more specifically, electrical circuits that combine circuit elements such as semiconductor elements and the like.

Further, in the above embodiments, the respective programs are described as being stored in advance (installed) on a computer-readable, non-transitory recording medium. However, the present disclosure is not limited to this, and the respective programs may be provided in forms of being recorded on a non-transitory recording medium such as a CD-ROM (Compact Disk Read Only Memory), a DVD-ROM (Digital Versatile Disk Read Only Memory), a USB (Universal Serial Bus) memory or the like. Further, the programs may be in forms of being downloaded from an external device via a network.

The flows of the processings described in the above embodiments are examples, and unnecessary steps may be deleted therefrom, new steps may be added thereto, or the order of processings may be rearranged, with a scope that does not depart from the gist of the present disclosure.

What is claimed is:

1. An information processing device comprising:
at least one processor that is configured to:
control rewriting of a recording device installed in a vehicle; and
on the basis of a first maximum number of times of rewriting that corresponds to a first interval in which functions of the recording device are guaranteed, set a second maximum number of times of rewriting in a second interval that is an interval that is shorter than the first interval.

2. The information processing device of claim 1, wherein
the at least one processor is configured to carry out restricting of rewriting in a case in which is it judged that the second maximum number of times of rewriting has been exceeded in the second interval.

3. The information processing device of claim 1, wherein
the at least one processor is configured to, in accordance with a request for securing, set the second maximum number of times of rewriting on the basis of the first maximum number of times of rewriting, the second interval, and a proportion of a secured region that that application is attempting to secure, per application.

4. The information processing device of claim 3, wherein
the at least one processor is configured to, in securing a storage region for the application, in a case of receiving a designation of an expected write size per predetermined interval that is shorter than the second interval, if a number of times of rewriting corresponding to the expected write size exceeds a maximum number of times of rewriting of a present point in time, allocate a number of times of rewriting corresponding to the expected write size as the second maximum number of times of rewriting, and, if the number of times of rewriting corresponding to the expected write size does not exceed the maximum number of times of rewriting, allocate the maximum number of times of rewriting of the present point in time as the second maximum number of times of rewriting.

5. The information processing device of claim 4, wherein
the at least one processor is configured to:
compute the maximum number of times of rewriting of the present point in time on the basis of a maximum number of times at which rewriting of the recording device is possible per predetermined interval that is computed by using a remaining number of times of rewriting of the present point in time and a predetermined remaining product life of the recording device, and a proportion of the secured region of the application with respect to physical size of the recording device, and the second interval that is the secured interval of the application, and
compute the number of times of rewriting corresponding to the expected write size on the basis of the number of times of rewriting corresponding to the expected write size and the second interval that is the secured interval of the application.

6. The information processing device of claim 1, wherein the at least one processor is configured to update a remaining number of times of the first maximum number of times of rewriting and a remaining number of times of the second maximum number of times of rewriting, each time that writing to the recording device is carried out.

7. The information processing device of claim 1, wherein a unit of the interval in the first interval and the second interval is a time period from shipping-out of the recording device from a factory, or traveled distance of the vehicle in which the recording device is installed.

8. A vehicle comprising:
the information processing device of claim 1; and
onboard equipment to which results of execution of an application managed by the information processing device are outputted.

9. An information processing method in which a computer executes processings of:
controlling rewriting of a recording device installed in a vehicle; and
on the basis of a first maximum number of times of rewriting that corresponds to a first interval in which functions of the recording device are guaranteed, setting a second maximum number of times of rewriting in a second interval that is an interval that is shorter than the first interval.

10. A non-transitory computer-readable storage medium storing an information processing program causing a computer to execute processings of:
controlling rewriting of a recording device installed in a vehicle; and
on the basis of a first maximum number of times of rewriting that corresponds to a first interval in which functions of the recording device are guaranteed, setting a second maximum number of times of rewriting in a second interval that is an interval that is shorter than the first interval.
